(19) United States
(12) Patent Application Publication
(10) Pub. No.: US 2023/0072722 A1
(43) Pub. Date: Mar. 9, 2023

(54) Optical Metasurfaces

(71) Applicants: Sintef TTO AS, Trondheim (NO); University of Southern Denmark, Odense (DK)

(72) Inventors: Sergey I. Bozhevolnyi, Odense (DK); Chao Meng, Odense (DK); Fei Ding, Odense (DK); Christopher Andrew Dirdal, Oslo (NO); Jo Gjessing, Oslo (NO); Paul Conrad Vaagen Thrane, Oslo (NO)

(73) Assignees: Sintef TTO AS, Trondheim (NO); University of Southern Denmark, Odense (DK)

(21) Appl. No.: 17/467,542

(22) Filed: Sep. 7, 2021

(51) Int. Cl. G02B 26/08; G02B 5/00

(52) U.S. Cl. CPC G02B 26/0833; G02B 5/008

(57) ABSTRACT

An apparatus comprising a first substrate comprising a nanostructured surface, thereby forming an optical metasurface; a mirror formed on a second substrate; and a mechanism arranged to move the first and second substrates relative to one another. The mechanism alters a separation between the first and second substrates between a first separation distance and at least a second separation distance. At the first separation distance the optical metasurface performs a first manipulation of incident light and at the second separation distance the optical metasurface does not perform the first manipulation of incident light. An optical system and a method are also described.

### FIELD OF THE INVENTION

This invention relates to optical metasurfaces (OMSs), systems including OMSs and methods involving OMSs.

### BACKGROUND OF THE INVENTION

OMSs represent subwavelength-dense planar arrays of nanostructured elements (often called meta-atoms) designed to control local phases and amplitudes of scattered optical fields, thus being able to manipulate radiation wavefronts at a subwavelength scale. Numerous applications have already been demonstrated in the past decade, including free-space wavefront shaping, versatile polarization transformations, optical vortex generation, optical holograph, to name a few. However, to date, most reported OMSs are static, featuring well-defined optical responses determined by OMS configurations that are set during fabrication.

### SUMMARY OF THE INVENTION

This invention corresponds to the findings of C. Meng, P. C. V. Thrane, F. Ding, J. Gjessing, M. Thomaschewski, C. Wu, C. Dirdal, S. I. Bozhevolnyi, Dynamic piezoelectric MEMS-based optical metasurfaces. Sci. Adv. 7, eabg5639 (2021) which is herein incorporated by reference.

The Applicant has appreciated that for more intelligent and adaptive systems, such as light detection and ranging (LIDAR), free-space optical tracking/communications and dynamic display/holography, it would be highly desirable to develop dynamic OMSs with externally controlled reconfigurable functionalities.

When viewed from one aspect the present invention provides an apparatus comprising:
a first substrate comprising a nanostructured surface, thereby forming an optical metasurface;
a mirror formed on a second substrate; and
a mechanism arranged to move the first and second substrates relative to one another to alter a separation between the first and second substrates between a first separation distance and at least a second separation distance wherein at said first separation distance said optical metasurface performs a first manipulation of incident light and at said second separation distance said optical metasurface does not perform said first manipulation of incident light.

It should be understood that a manipulation of light refers to any optical effect which is achieved through reflection of light from the optical metasurface which differs from specular reflection and could, for example, include diffraction, focussing, or defocussing.

Thus in accordance with the invention a manipulation of the incident light may be changed or turned off by moving the mirror away from the optical metasurface (OMS).

In a set of embodiments said first substrate has a first side and a second side, said second substrate being disposed to face said first side and said incident light being incident on said second side.

In a set of embodiments the apparatus comprises a feedback mechanism to regulate said separation distance and/or a degree of planarity of said second substrate.

When viewed from a second aspect the invention provides an optical system comprising a light source arranged to emit light having at least a first wavelength onto an apparatus, the apparatus comprising:
a first substrate comprising a nanostructured surface, thereby forming an optical metasurface;
a mirror formed on a second substrate; and
a mechanism arranged to move the first and second substrates relative to one another to alter a separation between the first and second substrates between a first separation distance and at least a second separation distance wherein at said first separation distance said optical metasurface performs a first manipulation of said light and at said second separation distance said optical metasurface does not perform said first manipulation of said light.

It should be understood that said first wavelength is typically the wavelength of the light in air. The light may have a plurality or range of wavelengths including the first wavelength.

In a set of embodiments of either aspect the first separation distance is less than 1/10 of said first wavelength.

In a set of embodiments of either aspect the second separation distance is more than ¼ of said first wavelength.

In a set of embodiments said first substrate has a first side and a second side, said second substrate being disposed to face said first side and said light source emitting said light onto said second side.

In a set of embodiments of either aspect said optical metasurface comprises a plasmon antenna array configured to form a gap surface plasmon metasurface when the separation between the first and second substrates is such that the optical metasurface performs a manipulation of incident light.

In a set of embodiments of either aspect said optical metasurface is configured to act as a blazed grating when the separation between the first and second substrates is such that the optical metasurface performs a manipulation of incident light.

In a set of embodiments of either aspect, at said second separation distance said optical metasurface performs a second manipulation of incident light. This may allow a manipulation still to take place (i.e. not be turned off) but to be changed in nature or degree.

In another set of embodiments of either aspect, at said second separation distance said optical metasurface performs substantially no manipulation of incident light -I.e. the manipulation is turned off. Incident light could, for example, simply be specularly reflected by the mirror.

In a set of embodiments of either aspect said mechanism is arranged to move the first and second substrates relative to one another to a third separation distance, between said first and second separation, whereat said optical metasurface performs a second manipulation of incident light. This may allow the manipulation to be changed and/or turned off. The manipulation could be changed in a stepwise manner or continuously. Correspondingly the separation distance may be changed in a stepwise manner or continuously.

In a set of embodiments of either aspect the second substrate is provided by a Micro-electromechanical systems (MEMS) arrangement such that the second substrate is translatable upon application of a voltage.

In a set of embodiments the optical system further comprises a feedback mechanism to regulate said separation distance and/or a degree of planarity of said second substrate.

When viewed from a third aspect the invention provides a method comprising:
providing an apparatus comprising:
   a first substrate comprising a nanostructured surface, thereby forming an optical metasurface; and
   a mirror formed on a second substrate;
setting a separation between the first and second substrates to a first separation distance;
directing incident light onto said optical metasurface, said optical metasurface performing a first manipulation of said incident light;
moving the first and second substrates relative to one another to a second separation distance; and
directing incident light onto said optical metasurface, said optical metasurface not performing said first manipulation of incident light.

In a set of embodiments, at said second separation distance said optical metasurface performs a second manipulation of incident light.

In a set of embodiments, at said second separation distance said optical metasurface performs substantially no manipulation of incident light.

In a set of embodiments the method comprises moving the first and second substrates relative to one another to a third separation distance, between said first and second separation, and directing incident light onto said optical metasurface, said optical metasurface performing a second manipulation of incident light.

In a set of embodiments of any aspect said manipulation comprises a polarization-independent dynamic beam steering.

In a set of embodiments of any aspect said manipulation comprises a polarization-independent dynamic 2D focusing.

### BRIEF DESCRIPTION OF DRAWINGS

Embodiments of the invention will now be described, by way of example only, with reference to the accompanying drawings in which:

FIG. 1A is a schematic diagram of an apparatus in accordance with an embodiment of the present invention;

FIG. 1B is a schematic diagram of the apparatus of FIG. 1A in a different state;

FIG. 1C is a schematic diagram of an apparatus in accordance with a further embodiment of the present invention;

FIG. 2A is a schematic diagram of an OMS unit cell, air gap, and mirror in accordance with an embodiment of the present invention;

FIG. 2B is a graph showing the complex reflection coefficient r calculated as a function of the nanobrick side length Lₓ and air gap tₐ;

FIG. 2C is a graph showing reflection phase and amplitude dependencies on the nanobrick length Lₓ for two extreme air gaps;

FIG. 2D is a plan view of a MEMS-OMS supercell according to an embodiment of the invention;

FIG. 2E is a cross sectional view of a MEMS-OMS supercell according to an embodiment of the invention;

FIG. 2F shows the distribution of the reflected TM electric field for an air gap of tₐ = 20 nm;

FIG. 2G shows the distribution of the reflected TM electric field for an air gap of tₐ = 350 nm;

FIG. 2H is a graph showing the diffraction efficiencies of different orders (|m| ≤ 1) calculated as a function of the air gap tₐ for incident light with an 800 nm wavelength;

FIG. 2I is a is a graph showing the diffraction efficiencies of different orders (|m| ≤ 1) calculated at the air gap tₐ =20 nm as a function of the incident wavelength;

FIG. 3A shows the distribution of the reflected TM electric filed for gradually varying air gaps;

FIG. 3B shows the distribution of the reflected TE electric field for gradually varying air gaps;

FIG. 4A shows optical images of the reflected light from MEMS-OMS under differing actuation voltages;

FIG. 4B is a graph showing the diffraction efficiencies of different orders (|m| ≤ 1) measured as a function of the actuation voltage;

FIG. 4C is a graph showing is a graph showing the diffraction efficiencies of different orders (|m| ≤ 1) measured as a function of the wavelength;

FIG. 4D is a graph showing the response time of the different diffraction orders (m = 0/+1) measured by actuating the MEMS mirror with a periodic rectangle signal;

FIG. 5A shows a plan view of an OMS designed for dynamic 2D focusing;

FIG. 5B shows a phase profile to focus radiation with focal length of 15 µm at 800 nm wavelength.

FIG. 5C shows the distribution of the reflected intensity for TM incident light with 800 nm wavelength at an air gap of tₐ = 20 nm;

FIG. 5D shows the distributions of the reflected intensity for TM incident light with 800 nm wavelength at an air gaps of tₐ = 350 nm;

FIG. 5E shows the distribution of the reflected TM electric field (x-component) at 800 nm wavelength for an air gap of tₐ = 20 nm;

FIG. 5F shows the distribution of the reflected TM electric field (x-component) at 800 nm wavelength for an air gap of tₐ = 350 nm;

FIG. 5G is a graph showing the focusing efficiencies calculated as a function of the operating wavelength λ and air gap tₐ, for TM polarizations;

FIG. 5H is a graph showing the focusing efficiencies calculated as a function of the operating wavelength λ and air gap tₐ, for TE polarizations;

FIG. 5I is a graph showing the focusing efficiencies calculated as a function of the air gap tₐ for TM/TE polarizations with respective 750, 800 and 950 nm wavelengths;

FIG. 6A is a graph showing the focusing efficiencies measured as a function of the actuation voltage for TM/TE incident light with 800 nm wavelength;

FIG. 6B shows optical images of the reflected light from the unstructured substrate and OMS area of the MEMS-OMS positioned at plane B with differing actuation voltages;

FIG. 7 is a schematic diagram of a system in accordance with the present invention;

FIG. 8 is a flow diagram illustrating a method in accordance with the present invention.

### DETAILED DESCRIPTION OF THE INVENTION

Realization of dynamic OMSs is very challenging because of the high density of array elements that are also arranged in nanometer-thin planar configurations. One of the currently investigated approaches relies on using dynamically controlled constituents, whose optical properties can be adjusted by external stimuli, thereby tuning their optical responses and reconfiguring the OMS functionalities. A variety of dynamic OMSs have been demonstrated by employing such materials, including liquid crystals (LCs), phase-change materials, two-dimensional (2D) materials and others. Despite certain progress achieved with these configurations, there are still unresolved critical issues. Thus, LCs inherently require the polarization-resolved operation, phase-change materials feature relatively slow response times, while OMSs based on 2D materials suffer from relatively low modulation efficiencies.

Another approach for realizing dynamic OMSs relies on direct modifying of their geometrical parameters via mechanical actuations. Initial attempts include OMSs fabricated on elastomeric substrates with dynamic functionalities enabled by OMS stretching. Faster and more accurate actuation can be achieved with micro-electromechanical systems (MEMS) that allow for electrically controlled actuation with nanometer precision and resolution, featuring also mature design and fabrication techniques. For example, varifocal lenses were realized with MEMS-actuated metasurface doublets, whose relative positions were controlled by MEMS actuators, resulting in continuous focal length tuning. In this configuration however, the two OMSs and their individual responses are not modified, making it difficult to use for dynamic wavefront manipulation in general. Very recently, through directly structuring OMSs on a movable silicon membrane of a silicon-on-insulator (SOI) wafer, dynamic one-dimensional (1D) wavefront shaping with fast response speed (~1 MHz) was demonstrated. In this case, direct OMS integration into the MEMS-actuated membrane leads to certain design limitations, resulting in polarization dependent performance and impeding implementation of 2D wavefront shaping.

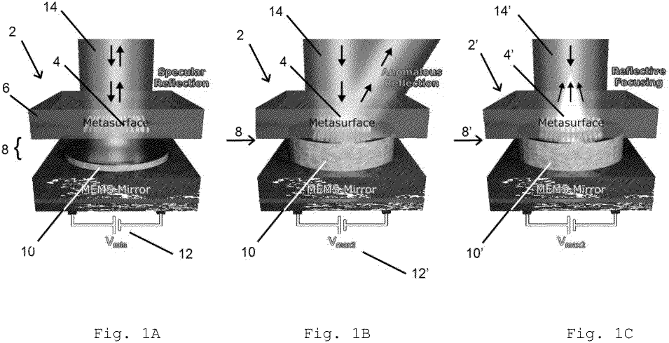

In the present disclosure, by combining a thin-film piezoelectric MEMS with the gapsurface plasmon (GSP) based OMS, we develop an electrically driven dynamic MEMS-OMS platform for realizing efficient, broadband and fast 2D wavefront shaping in reflection. The disclosed embodiments split the conventional GSP based OMS, so that an OMS layer containing metal nanobricks and back reflector are physically separated by an electrically controlled air gap, with an ultra-flat MEMS mirror serving as a moveable back reflector as will now be described in more detail with reference to FIGS. 1A to 1C.

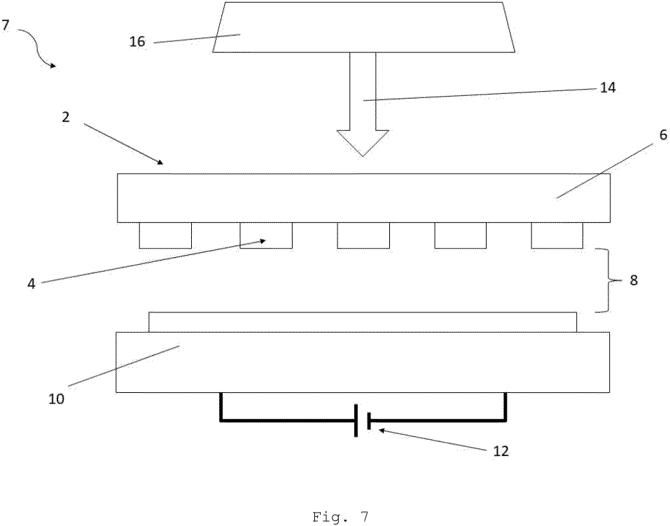

FIGS. 1A to 1C and 7 show schematically part of an optical apparatus in accordance with an embodiment of the invention. An OMS 2 is provided comprising a gold nanobrick array 4 (such as that disclosed in N. Yu, F. Capasso, Flat optics with designer metasurfaces. Nat. Mater. 13, 139-150 (2014) which is hereby incorporated by reference)on a glass substrate 6. Separated from the OMS 2 by an air gap 8 is a MEMS mirror 10 (such as that disclosed in T. Bakke, A. Vogl, O. Zero, F. Tyholdt, I. R. Johansen, D. Wang, A novel ultra-planar, long-stroke and low-voltage piezoelectric micromirror. J. Micromech. Microeng. 20, 064010 (2010) which is hereby incorporated by reference). A voltage source 12 is provided to control actuation of the MEMS mirror 10. In the position shown in FIG. 1A, a minimum voltage is applied to the MEMs mirror 10 so that the reflective surface thereof does not extend very far from the body. This results in an initial gap (separation distance 8) of ~ 350 nm between the OMS 2 and the MEMS mirror 10. Incident light 14 from a light source 16 is specularly reflected by the MEMS-OMS combination 2, 10 substantially without being manipulated by the OMS regardless of the detailed design of the nanobrick array 4.

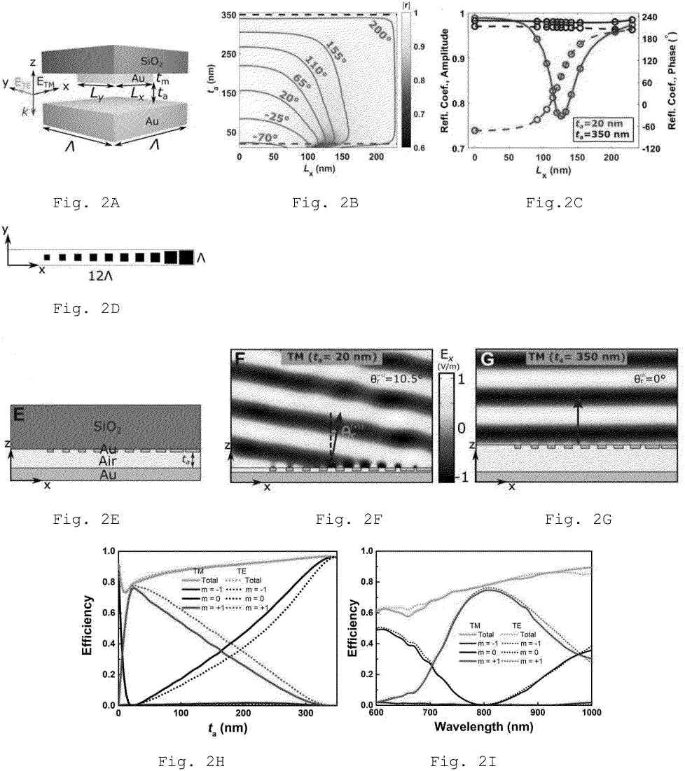

In the position of FIG. 1B, a greater voltage is applied by the voltage source 12 to move the reflective surface of the MEMS mirror 10 much closer to the underside of the OMS 2 - e.g. with a separation distance 8 of ~ 20 nm. This results in incident light 14 being manipulated by the OMS 2. In the illustrated example, the OMS 2 is configured to act as a blazed grating, with the reflected light being predominantly directed into the first diffraction order. This specific manipulation of light is known as anomalous reflection. The structure of the nanobrick array 4 is described in more detail below in relation to FIG. 2D.

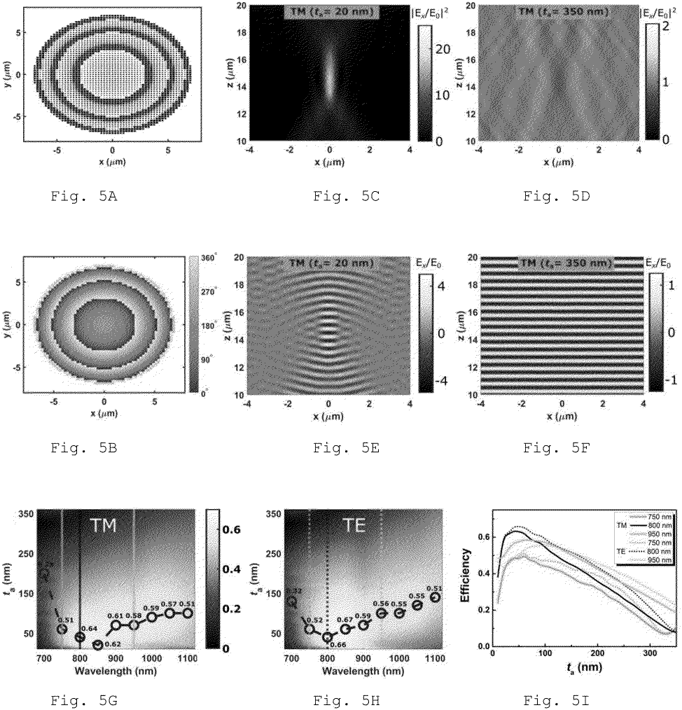

FIG. 1C represents another embodiment of the invention with a different design for the nanobrick array 4' in which the nanobrick geometries are chosen such that the OMS 2' acts as a focusing lens. As such, at a separation distance 8' which is also ~ 20 nm, the OMS 2' manipulates the incident light 14' to result in a focusing effect. The structure of nanobrick array 4' is described in more detail below in relation to FIG. 5A.

Importantly, OMSs 2, 2' and MEMS mirrors 10, 10' are designed and fabricated in separate processing paths and then combined, ensuring thereby the design freedom on both sides and reducing the fabrication complexity. The choice of the piezoelectric MEMS to be combined with the GSP based OMS can be dictated by specific advantages of the former, including continuous out-of-plane actuation capability and low voltage/power operation, that enables the development of continuously tunable/reconfigurable MEMS-OMS components with ultra-compact sizes and low power consumption.

With this platform, we experimentally demonstrate dynamic polarization-independent beam steering (FIG. 1B) and reflective 2D focusing (FIG. 1C). By electrically actuating the MEMS mirror 10, 10' and thus modulating the MEMS-OMS distance 8, 8', polarization-independent dynamic responses with large modulation efficiencies are demonstrated. Specifically, when operating at a wavelength of 800 nm, the beam steering efficiency (in the +1^{st} diffraction order) reaches 40% and 46% for the respective TM and TE polarizations (electric field parallel/perpendicular to the reflection plane, respectively), where 76% and 78% are expected from simulations. While the beam focusing efficiency reaches 56% and 53% (64% and 66% expected from simulations). Furthermore, the dynamic response of the investigated MEMS-OMSs is characterized with the respective rise/fall times of ~ 0.4/0.3 ms, characteristics that can be further improved by using MEMS mirrors optimized for bandwidth in the MHz range. For example, by using MEMS actuated membranes to ensure ~ 30 MHz switching speeds.

### Operational Principle

Similar to the conventional GSP based OMSs, the proposed MEMS-OMS configuration represents a metal/insulator/metal (MIM) structure composed of a bottom thick gold layer atop a silicon substrate (MEMS mirror), an air spacer and a top layer with 2D arrays of gold nanobricks on a glass substrate (OMS structure).

The air spacer gap tₐ can be finely adjusted by actuating the MEMS mirror (see FIG. 2A). When the air gap is small (tₐ < 200 nm), the optical responses of OMS unit cells are determined by the GSP excitation and resonance in the MIM configuration and thus by nanobrick dimensions. In order to progress further towards the design of dynamically controlled MEMS-OMSs, several geometrical OMS parameters must be determined. First, we set the operating wavelength at 800 nm and choose the OMS unit cell size of 250 nm that should be substantially smaller than the operating wavelength. Assuming the smallest achievable air gap is between 20 - 50 nm, the nanobrick thickness tₘ is then optimized to achieve a wide phase coverage with large reflection amplitudes, resulting in the choice of tₘ = 50 nm. The nanobrick lateral dimensions, side lengths, are chosen to be equal to ensure the polarization-independent optical response. Analysis of the complex reflection coefficients of the OMS conducted for increased air gaps reveals that the phase gradient for different nanobrick side lengths progressively decreases, with the reflection phase and amplitude becoming independent on the nanobrick length at an air gap of tₐ = 350 nm (FIGS. 2, B and C). This drastic transformation in the optical response is related to strong dependencies of the GSP excitation (at normal incidence) and GSP reflection at nanobrick terminations on the air gap: both decrease rapidly for increased air gaps, thereby attenuating and eventually eliminating the GSP resonance. The observed transformation of the reflection phase response (FIG. 2C) implies a simple and straightforward approach to realize dynamically controlled MEMS-OMSs: for a given smallest air gap (for example, 20 nm), one can design any conceivable GSP-based OMS, whose functionality can then be switched on and off by moving the MEMS mirror. Hereafter we demonstrate this approach by realizing dynamically controlled polarization-independent beam steering and reflective 2D focusing.

### Polarization-Independent Dynamic Beam Steering: Design

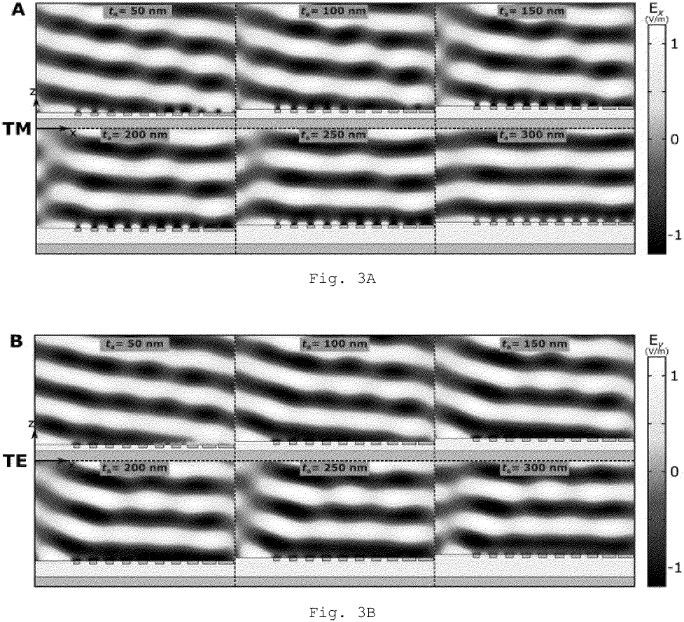

The beam steering MEMS-OMS design shown in FIG. 1B will now be described in further detail with reference to FIGS. 2A to 2I, and FIGS. 3A and 3B.

FIG. 2A is a schematic of the OMS unit cell including the air gap and gold mirror. FIG. 2B shows the complex reflection coefficient r calculated as a function of the nanobrick side length Lₓ and air gap 8, labelled tₐ with other parameters being as follows: λ = 800 nm, tₘ = 50 nm, Λ = 250 nm and L_{y} = Lₓ. Coloration is related to the reflection amplitude, while the magenta lines represent constant reflection phase contours.

FIG. 2C shows the reflection phase (dashed) and amplitude (solid) dependencies on the nanobrick length Lₓ for two extreme air gaps: tₐ = 20 (red) and 350 (blue) nm. Circles represent the nanobrick sizes selected for the OMS supercell designed for dynamic beam steering. FIG. 2D is a plan view and FIG. 2E is a cross section of the designed MEMS-OMS supercell. FIGS. 2F and 2G show distributions of the reflected TM electric field (x-component) at 800 nm wavelength for air gaps of tₐ = 20 and 350 nm, respectively. FIG. 2H shows diffraction efficiencies of different orders (|m| ≤ 1) calculated as a function of the air gap tₐ for TM/TE incident light with 800 nm wavelength. FIG. 2I shows diffraction efficiencies of different orders (|m| ≤ 1) calculated at the air gap tₐ = 20 nm as a function of the wavelength for TM/TE incident light.

The MEMS-OMS design for realizing dynamically controlled polarization-independent beam steering involves the choice of the number N of unit cells in the OMS supercell that in turn determines the steering angle θ for the given unit cell size Λ = 250 nm, refractive index of silica glass n = 1.46 and light wavelength λ = 800 nm: sin θ = λ/nNΛ. Bearing in mind experimental conditions, we chose an OMS supercell consisting of twelve cells so that the steering angle is θ = 10.5° in glass (corresponding to 15.5° in air), facilitating the characterization of well-separated 0^{th}/±1^{st} diffraction orders with a 20×/0.42 objective. Following the approach described above, the phase response calculated with the air gap tₐ = 20 nm for different nanobrick lengths is used to select the twelve nanobricks (FIG. 2C, red circles) and arrange them into an array along the x direction (FIGS. 2, D and E) to mimic the reflection coefficient of an ideal blazed grating: r(x) = Aexp(i2πx/Λ_{sc}), where A ≤ 1 is the reflection amplitude, and Λ_{sc} = 12Λ is the grating (supercell) period. The available phase range at tₐ = 20 nm is slightly over 270° (the red dashed line in FIG. 2C), implying that it is impossible to design a supercell with twelve different unit cells ensuring a constant phase gradient (the latter requires the phase range of 11×30° = 330°). One possible approach to deal with this problem is to increase the phase (discretization) steps to 90°, so that the required phase range would decrease to 3x90° = 270°, resulting in the possibility to compose the supercell from duplicated (Λ_{sc} = 4Λ×2 = 8Λ) or triplicated (Λ_{sc} = 4Λ×3 = 12Λ) cells. Our simulations suggested another approach, in which two unit cells were left out empty, i.e., without nanobricks, while the other ten nanobricks cover the available phase range of 270°, thus ensuring better sampling of the phase profile and improving the efficiency of diffraction to the desired +1^{st} order. Note that, in the absence of absorption, one might opt for another approach, such as doubling only the cells with extreme (minimum and maximum) phase responses (60).

The reflected electric field (x/y-components) calculated for thus designed MEMS-OMS under TM/TE incident light at 800 nm wavelength with tₐ = 20 nm manifest smooth wavefronts travelling in the direction of the +1^{st} diffraction order (FIG. 2F). For increased air gaps, the phase gradients produced by the supercell nanobricks progressively decrease as expected (FIGS. 2, B and C), with the phase gradient becoming zero and the reflected field returning to the specular reflection at an air gap of tₐ = 350 nm (FIG. 2G). Here, we remark that our simulations presented hereafter are concerned with the air gaps limited by 350 nm since, for large air gaps, a MEMS-OMS would function in a completely different regime determined by multiple and periodic positions of Fabry-Pérot resonances, which is discussed in further detail below. The associated decrease in the +1^{st} order diffraction efficiency and increase in the 0^{th} order one as a function of the air gap are practically linear, promising large modulation efficiencies available with the actuated MEMS-OMS (FIG. 2H). Thus, +1^{st}/0^{th} order diffraction efficiencies are expected to change from ~77%/0% to 0%/96% (for both TM and TE polarizations) when changing the air gap from 20 to 350 nm.

The designed MEMS-OMS is expected to exhibit the broadband operation similar to that known for conventional GSP-based OMSs. Note that the MEMS-OMS performance at large air gaps is equivalent to that of a mirror, with the value of a suitably large air gap being proportional to the operating wavelength (see the consideration of Fabry-Pérot-based operation below). With this caveat in mind, the MEMS-OMS overall performance is determined by that at the smaller air gap of tₐ = 20 nm, suggesting a 1-dB bandwidth of ~ 150 nm near the operating wavelength of 800 nm (FIG. 2I). Note that, while the reflected field distribution for the air gap of 20 nm (FIG. 2F) is not ideal for a number of reasons: insufficient phase range, unequal amplitude reflection coefficients etc., the performance of the MEMS-OMS at the design wavelength of 800 nm is practically ideal with only the first diffraction order being nonzero (FIG. 2I), i.e., this nonideal wavefront formation is of no practical importance for the device operation. As a final comment, it should be mentioned that, given the possibility of small air gap adjustments around the designed air gap of tₐ = 20 nm, the diffraction efficiencies for different wavelengths could be enhanced, thus improving the effective bandwidth of the MEMS-OMS device.

It is envisaged that mirror positions corresponding to air gaps between tₐ = 20 nm and tₐ = 350 nm may be used, and the interaction of incident light with the OMS at such intermediate distances will now be discussed with reference to FIGS. 3A and 3B which show the distributions of the reflected TM and TE electric fields respectively at an 800 nm wavelength for gradually varying air gaps tₐ = 50, 100, 150, 200, 250 and 300 nm. Redistributions of the power between diffracted orders for gradually varying air gaps are interconnected with the corresponding modifications in the reflected fields, undergoing gradual transition (FIG. 3) between those primarily diffracted (at tₐ = 20 nm) to those primarily reflected (at tₐ = 350 nm). Thus it can be seen that the beam steering effect of the MEMS-OMS is reduced as the size of the air gap approaches 350 nm.

### Polarization-Independent Dynamic Beam Steering: Characterization

The MEMS-OMS for polarization-independent beam steering designed above (FIG. 2) was assembled from a separately fabricated OMS, an ultra-flat MEMS mirror and a printed circuit board. As discussed above, the possibility of fabricating the MEMS mirror and OMS separately simplifies the design and fabrication processes, for example by allowing the two components to be produced in separate processing lines with different minimum line width capabilities. The fabricated MEMS mirror and OMS were characterized individually using optical and scanning electron microscopes. When joining the MEMS mirror and OMS it is preferable to avoid any particles that can obstruct the mirror from getting close enough to the OMS. Because the mirror [i.e., 3 mm in diameter] was much larger than the OMS [i.e., 30 × 30 µm² in size], the OMS was fabricated on top of a 10-µm-high pedestal, the idea being that any particles smaller than 10 µm outside the pedestal will not prevent the OMS and MEMS mirror from coming into contact. This pedestal did not affect the fabrication of the nanobricks, featuring overall consistency with the design apart from slightly rounded corners and minor size deviations that are not expected to produce noticeable deterioration in the OMS performance. After assembling the MEMS-OMS, the MEMS-OMS separation was estimated using white light interferometry to be ∼2 µm, which is well within the ∼ 6-µm-large moving range of the MEMS mirror. Following that, we estimated the smallest achievable separation between the MEMS mirror and OMS substrate surface (crucial for efficient modulation) by using a multi-wavelength interferometry. We found by actuating the MEMS mirror that, for several assemblies, this gap (tₘ + tₐ) can be as small as ∼100 nm, corresponding to tₐ ~ 50 nm, and these samples were then selected for further optical characterizations.

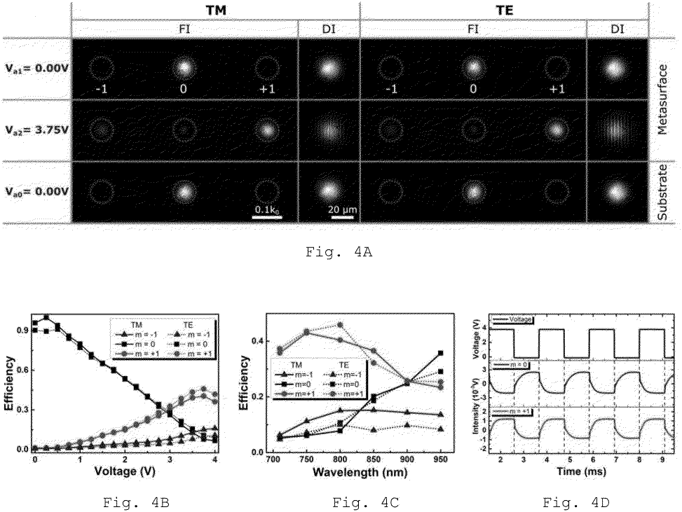

FIG. 4A shows optical images at the direct object (DI) and Fourier image (FI) planes of the reflected light from MEMS-OMS under actuation voltages of Vₐ₁ = 0.00 V (upper panel) and Vₐ₂ = 3.75 V (middle panel) for TM/TE normally incident light with 800 nm wavelength. Reflected light from unstructured substrate (bottom panel) in the MEMS-OMS device is also recorded as a reference. FIG. 4B shows the diffraction efficiencies of different orders (|m| ≤ 1) measured as a function of the actuation voltage for TM/TE incident light with 800 nm wavelength. FIG. 4C shows the diffraction efficiencies of different orders (|m| ≤ 1) measured as a function of the wavelength for TM/TE incident light. FIG. 4D shows the response time of the different diffraction orders (m = 0/+1) measured by actuating the MEMS mirror with a periodic rectangle signal.

To characterize the MEMS-OMS performance, we used a wavelength-tunable (~ 700 - 1000 nm) laser with the corresponding optical, polarization and imaging components (see Materials and Methods. The MEMS mirror is electrically actuated to modulate the optical response of the MEMS-OMS observed visually in both direct object (OMS surface) and Fourier image planes (FIG. 4A). In the direct object images, this effect of power redistribution is seen in the appearance (at non-zero actuation voltages) of well-pronounced interference fringes formed due to the interference between the residual specular reflection and the + 1^{st} order diffracted beam. For both polarizations, the redistribution of radiation power between the 0^{th} and + 1^{st} diffraction orders are well pronounced, reaching the maximum contrast at 3.75 V with the diffraction efficiencies of 40%/46% for the respective TM/TE polarizations (FIGS. 4, A and B). The experimentally obtained diffraction efficiencies (FIG. 4B) are noticeably smaller than those expected from the simulations (FIG. 2H), discrepancies that are somewhat expected and attributed to additional absorption in gold nanobricks due to surface scattering and grain boundary effects as well as increased damping associated with a few-nm-thin titanium adhesion layer between gold-glass interfaces. It should be noted that there is also a minor difference to be expected because of different media considered when determining the theoretical and experimental efficiencies (see Materials and Methods). The MEMS-OMS operation is found polarization-independent and broadband, exhibiting the 1 dB bandwidth of ~ 150 nm (FIG. 4C). By actuating the MEMS mirror with a periodic rectangle signal and detecting the spatially separated 0^{th}/+ 1^{st} order diffraction fields, one observes relatively fast switching with the rise/fall times of ~ 0.4/0.3 ms, respectively (FIG. 4D). The response speed is related to the intrinsic oscillation frequency of the MEMS mirror, thus being dependent on the MEMS design parameters such as geometry, weight, stiffness and so on. Note that the standard thin-film MEMS mirror used is rather large (~ 3 mm in diameter) with its surface area orders of magnitude larger than that of the OMS area (~ 30 × 30 µm² in size), considerably slowing down the dynamic response. Bearing in mind the possibility of optimizing the MEMS mirror for fast switching speeds, one should expect reaching operation bandwidths in the MHz range, indeed, current state of the art in thin-film piezoelectric MEMS can achieve ~ 30 MHz switching frequencies. In terms of stability and repeatability of operation, thin-film piezoelectric MEMS can survive more than 10¹¹ cycles at full 20 V AC cycles for standard operating conditions (23° C., 35% relative moisture), drifting by ~ 10% during its lifetime, although the repeatability within ~ 1 nm is feasible with accurate position feedback by, e.g., optical, capacitive or piezoresistive sensing. As far as the vibration instability is concerned, it is preferable that the MEMS device and glass plate resonances are not excited, which is usually the case once resonance frequencies are above 1 kHz. The current MEMS device has a resonance frequency of ~ 4 kHz, and that of the glass plate is much higher. Consequently, no vibration instability is expected under normal circumstances and none was observed.

Concluding the presentation of the demonstrated MEMS-OMS for polarization-independent beam steering, it will be understood that, although the experimentally observed performance (FIG. 4) is somewhat inferior to that expected from our simulations (FIG. 2), the experimental performance can be improved. The deterioration can be attributed partly to fabrication imperfections and to the smallest air gap tₐ that was achieved in practice. It seems that the air gap decreases with applying the actuation voltage only up to ~ 3.75 V, resulting thereby in increasing + 1^{st} and decreasing 0^{th} order diffraction efficiencies, whereas for larger voltages the MEMS mirror starts to move slightly away from the OMS, probably because of the residual contaminants on the substrate or bending at the pedestal edges which prevent the MEMS mirror from moving further closer to the OMS surface. Both better fabrication accuracy and smaller air gaps are feasible and expected to be realized in further experiments.

### Polarization-Independent Dynamic 2D Focusing: Design

The focusing MEMS-OMS design shown in FIG. 1C will now be described in further detail with reference to FIGS. 5A to 5I.

FIG. 5A shows a plan view of the OMS designed for dynamic 2D focusing. FIG. 5B shows a phase profile to focus radiation with focal length of 15 µm at 800 nm wavelength. FIGS. 5C and 5D show the distributions of the reflected intensity for TM incident light with 800 nm wavelength at air gaps of tₐ = 20 and 350 nm, respectively. FIGS. 5E and 5F show the distributions of the reflected TM electric field (x-component) at 800 nm wavelength for air gaps of tₐ = 20 and 350 nm, respectively. FIGS. 5G and 5H show the focusing efficiencies calculated as a function of the operating wavelength λ and air gap tₐ, for TM/TE polarizations. The green, black and cyan lines indicate the cases of λ = 750, 800 and 950 nm, respectively. FIG. 5I shows the focusing efficiencies calculated as a function of the air gap tₐ for TM/TE polarizations with respective 750, 800 and 950 nm wavelengths.

The MEMS-OMS design for realizing dynamically controlled polarization-independent 2D beam focusing in reflection involves the choice of diameter D and focal length f of the OMS lens that in turn determines the numerical aperture NA for the given refractive index in the image space n = 1.46 at an incident wavelength of λ = 800 nm: NA = nsin[tan⁻¹(D/2f)]. To realize strong focusing, we chose D= 14 µm and f = 15 µm, so that NA ≈ 0.62 is expected, which should be adequate to enable high-efficiency reflective 2D focusing. Following the same design approach used in demonstrating MEMS-OMS for dynamic beam steering, we use the phase response calculated with air gap tₐ = 20 nm for different nanobrick lengths (the red dashed line in FIG. 2C) to extract the proper unit cells and arrange them into a circular region with D = 14 µm (FIG. 5A), approximating a hyperboloidal phase profile:

$${ϕ}_{2 D} = \frac{2 π}{λ} n \left(f - \sqrt{{x}^{2} + {y}^{2} + {f}^{2}}\right)$$

in the xy-plane (FIG. 5B). The above phase profile is also discretized with the step size Λ = 250 nm along both x/y- directions, matching the unit cell size (Λ = 250 nm). In contrast to the previous work, we do not limit the choice of unit cells to a discrete design space [i.e., unit cells with discrete phase steps of 45°]. Instead, appropriate lengths of the nanobricks are chosen from the entire space of simulation results (the red dashed line in FIG. 2C), thus ensuring better sampling of the 2D phase profile with minor deviations from the required one (FIG. 5B). The deviation between the required and available phase profiles results mostly from the achievable phase coverage of ~ 270°, a limitation that could be circumvented by including more complex unit cell elements such as detuned GSP resonators that can also be constructed square-like to ensure the polarization independent operation, or by using cross-like nanobricks allowing for a wider phase coverage.

Bearing in mind high computational demands when simulating 2D focusing (and thus aperiodic) OMSs, we estimate the focusing performance by simulating the corresponding (reduced to a 1D aperiodic configuration) OMS, which is designed to provide a 1D hyperboloidal phase profile:

$${ϕ}_{1 D} = \frac{2 π}{λ} n \left(f - \sqrt{{x}^{2} + {f}^{2}}\right)$$

while the D, f and λ are the same as that of the above-designed OMS with the 2D phase profile. The reflected intensity distributions calculated for this simplified MEMS-OMS under TM/TE incident light at 800 nm wavelength with tₐ = 20 nm manifest high focusing quality with a diffraction-limited spot situated at the focal length of ~ 15 µm (FIG. 5C). For increased air gaps, the phase gradients produced by nanobricks with different lengths progressively decrease (FIGS. 2, B and C), approaching zero at an air gap of 350 nm with the reflection transformed into specular reflection (FIG. 5D). The associated reflected electric fields calculated near the focus display smoothly converging and planar wavefronts at air gaps tₐ = 20 (FIG. 5E) and 350 nm (FIG. 5F), respectively, implying high-efficiency operation of the actuated MEMS-OMS. Taking into account the possibility of adjusting the air gap to maximize the focusing efficiency at other (than the design) wavelengths, we evaluated the focusing efficiencies achievable at different wavelengths with varied air gaps (FIGS. 5, G and H). The maximum achievable focusing efficiencies at the design wavelength of 800 nm are estimated to be ~64%/66% (TM/TE) for the air gap of ~ 20 nm as expected. For other wavelengths, the polarization-independent focusing behavior is well-maintained, while the corresponding maximal focusing efficiencies are expected to achieve at slightly different air gaps. To better visualize this feature, the focusing efficiency as a function of the air gap is explicitly plotted for distinct wavelengths of 750, 800 and 950 nm (FIG. 5I), showing for all wavelengths a nearly linear decrease of the efficiency for increasing air gaps without noticeably changes in the reflected field distributions.

### Polarization-Independent Dynamic 2D Focusing: Characterization

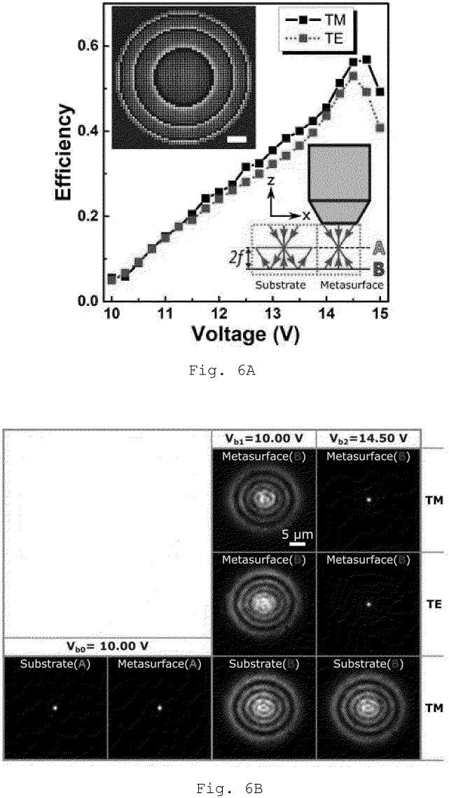

The MEMS-OMS for polarization-independent dynamic reflective 2D focusing designed as described above (FIG. 5) was assembled following the fabrication and pre-characterization processes similar to those employed when assembling the dynamic beam steering MEMS-OMS. Optical microscopy and SEM are employed for monitoring the possible contaminants on the OMS surface as well as the fabrication quality (the upper-left inset of FIG. 6A).

FIG. 6A shows focusing efficiencies measured as a function of the actuation voltage for TM/TE incident light with an 800 nm wavelength. The upper-left inset is a typical SEM image of the OMS representing 14-µm-diameter and 250-nm-period array of differently sized gold nanobricks designed for dynamic 2D focusing, scalebar 2 µm. The bottom-right inset illustrates the measurement method in which the incident beam is focused at plane A (focal plane of the objective) and impinges on the unstructured substrate or OMS area of the MEMS-OMS at plane B (2f distance away from the focal plane of the objective), resulting in respective divergent or focused reflected fields.

FIG. 6B shows optical images of the reflected light from the unstructured substrate and OMS area of the MEMS-OMS positioned at plane B with actuation voltages of V_{b1} = 10.00 V and V_{b2} = 14.50 V for TM/TE incident light at 800 nm wavelength. The reflected light from the unstructured substrate and OMS area of the MEMS-OMS positioned at plane A was also recorded as a reference.

To characterize the dynamic focusing MEMS-OMS, we electrically actuated the MEMS mirror and observed corresponding optical responses in the direct object plane (FIG. 6B). Since the MEMS-OMS was designed to exhibit a very short focal length of ~ 15 µm, it was not possible to directly access the focal plane using a beam splitter and a low-divergent incident laser beam. Instead, the focusing effect was verified by illuminating the MEMS-OMS with a focused incident beam and placing the MEMS-OMS surface plane B at a distance of ~ 2f (the double focal length of the MEMS-OMS) away from the incident beam focal plane A (see inset in FIG. 6A). According to the ray optics, the beam reflected by the OMS (when close to the MEMS mirror) will then be focused again at the focal plane of the objective (plane A in the bottom-right inset of FIG. 6A). At the same time, the reflection from the unstructured substrate surface (outside the OMS area) would be strongly diverging (see the bottom-left inset in FIG. 6A). If one moves the MEMS-OMS surface to plane A, the reflection behavior will be reversed: the reflection by the OMS will be diverging (after the objective) and that by the unstructured surface -collimated..

In the current case with the dynamic focusing MEMS-OMS, it is expected for the MEMS-OMS arrangement to switch between the focusing configuration, when the applied voltage would bring the OMS very close to the MEMS mirror, and the mirror reflecting configuration for relatively small applied voltages that would correspond to sufficient large OMS and MEMS mirror separations.

To observe this transformation, we monitored the reflected light from the MEMS-OMS positioned at plane B while actuating the MEMS mirror. For both polarizations, the switching of the reflected light between the mirror (at V_{b1} = 10.00 V) and focusing (at V_{b2} = 14.50 V) cases was clearly visualized (FIG. 6B), with the focusing efficiencies reaching their maxima of ~56%/53% at V_{b2} = 14.50 V for the respective TM/TE light incidence at the wavelength of 800 nm (FIG. 6A). At the same time, the reflection from the unstructured substrate surface was not influenced with the applied voltages, revealing however that the reflection from the substrate at plane A is strikingly similar to the TM/TE reflection from the OMS at plane B with the applied voltage being V_{b2} = 14.50 V (FIG. 6B). The latter evidences a rather high efficiency and excellent quality of polarization independent focusing by the MEMS-OMS at V_{b2} = 14.50 V. The dynamic evolution of the reflected field from the MEMS-OMS positioned at plane B, induced by actuating the MEMS mirror with stepwise increased voltages from 10.00 to 14.50 V, is clearly observed with a CCD camera. Due to the usage of the same MEMS component as that in the dynamic beam steering MEMS-OMS, similar response time of ~ 0.4 ms is expected. It is finally worth noting that, according to the current state of the art in thin-film piezoelectric MEMS techniques, MEMS-OMS components with ~ MHz switching bandwidth should be feasible and expected for further developments.

Disclosed herein is an electrically driven dynamic MEMS-OMS platform combining a thin-film piezoelectric MEMS mirror with a GSP-based OMS. This platform offers controllable phase and amplitude modulation of the reflected light by finely actuating the MEMS mirror. We have designed and experimentally demonstrated MEMS-OMS devices operating in the near-infrared wavelength range for dynamic polarization-independent beam steering and reflective 2D focusing, both exhibiting efficient (~ 50%), broadband (~ 20% near the operating wavelength of 800 nm) and fast (< 0.4 ms) operation. It will be understood that the operation bandwidth can be drastically increased when using circularly polarized light whose transformation relies on the OMS making use of the geometrical (Pancharatnam-Berry) phase. The operation of both devices makes use of the phase response transformation when changing the MEMS-OMS separation by adjusting the applied voltage, e.g. within the range of ~ 4V. The same operation principle can be used to design a MEMS-OMS for dynamically controlling any functionality available for conventional GSP-based OMSs, from polarization control/detection to vector/vortex beam generation: for a given smallest air gap, one designs the GSP-based OMS exhibiting a required functionality that can then be switched on and off by moving the MEMS mirror towards and away from the OMS surface.

Moreover, the nontrivial modification of the size-dependent phase response with the MEMS-OMS separation (FIG. 2B), which can accurately be adjusted by electrical MEMS actuation, suggests a possibility of realizing more sophisticated dynamic functionalities. One functionality of particular interest to commercial applications is the possibility of switching between multiple diffraction orders in order to allow for quasi-continuous beam steering (for use in, e.g., LIDAR applications). Thus, we have also designed and experimentally demonstrated the MEMS-OMS device for polarization-independent dynamic beam steering between three (0^{th}, 1^{st} and 2^{nd}) diffraction orders, corresponding to reflection angles of 0°, 5.2° and 10.5° in glass (corresponding to 0°, 7.7° and 15.5° in air) under normally incident light with 800 nm wavelength.

In other embodiments the MEMS mirror may not be brought very close (~100 nm) to the OMS surface. For large MEMS-OMS separations, one can make use of localized plasmon resonances due to excitation of short-range surface plasmon-polaritons (SR-SPPs) in thin metal films. Our preliminary simulations showed that the SR-SPPs resonances hybridize with the Fabry-Pérot resonances (supported with wavelength-large air gaps) similar to the above-considered route to modify the OMS phase response by controlling the air gap. Note that at certain air gaps (separated by half of the wavelength) the reflected phase becomes independent of the nanobrick size, resulting thereby in the mirror-like behavior. In between these air gaps, there are gaps at which the phase does depend on the nanobrick size. At these gaps, the nanobrick sizes can be chosen in a manner enabling one to realize a phase-gradient metasurface. Switching between these two distinct air gaps results therefore in switching between the mirror-like and gradient metasurface behavior, which is similar to switching between the same types of responses of the GSP-based metasurfaces. With this approach the MEMS-OMS can be operated near the air gap of ~ 1 µm or more, thus avoiding the need to realize nm-sized air gaps. Overall, diverse functionalities with dynamically reconfigurable performances can be realized using the developed MEMS-OMS platform, thus opening fascinating perspectives for successful realization of high-performance dynamically controlled devices with potential applications in future reconfigurable/adaptive optical systems.

### Materials and Methods

### Simulation Methods

All numerical simulations were performed using COMSOL Multiphysics 5.5. We modeled one individual Glass/Au/Air/Au unit cell (FIG. 2A), where periodic boundary conditions were applied in both x/y- directions, and linearly x-polarized light at the design wavelength of 800 nm was normally incident onto the unit cell from the upper glass layer. The permittivity of Au is described by the interpolated experimental values, and the glass layer is taken as a lossless dielectric with a constant refractive index of 1.46. Then the complex reflection coefficients (FIG. 2B) were calculated as a function of nanobrick lengths Lₓ, and air gap tₐ with other parameters being as follows: λ = 800 nm, tₘ = 50 nm, Λ = 250 nm, and L_{y} = Lₓ to ensure the polarization-independent optical responses.

To design the MEMS-OMS for dynamic beam steering, the phase response calculated with the air gap tₐ = 20 nm for different nanobrick lengths is used to select the lengths of 12 nanobricks (FIG. 2C) for approximating the reflection coefficient of an ideal blazed grating: r(x) = Aexp(i2πx/Λ_{sc}), where A ≤ 1 is the reflection amplitude, and Λ_{sc} = 12Λ is the grating (supercell) period. Reflected light directed to different diffraction orders are monitored, with different air gaps tₐ and incident wavelengths λ for estimating the dynamic diffraction efficiencies and operation optical bandwidths, respectively (FIGS. 2, D to I). Here, the diffraction efficiencies are defined as the ratios of the light intensities (in glass) in the corresponding diffraction orders to the incident (in glass) light intensity. MEMS-OMS for dynamic beam focusing is designed and simulated in a similar fashion. Nanobricks from the phase response calculated with the air gap tₐ = 20 nm for different nanobrick lengths (FIG. 2C) are selected to approximate a 1D hyperboloidal phase profile of:

$${ϕ}_{1 D} = \frac{2 π}{λ} n \left(f - \sqrt{{x}^{2} + {f}^{2}}\right)$$

within a 14-µm-diameter region in the xy-plane. Reflected fields are monitored to visualize the dynamic beam focusing and estimate corresponding focusing efficiencies as a function of the gap sizes tₐ and incident wavelengths λ, for both TM/TE polarizations (FIGS. 5, C to I). Here, the focusing efficiencies are defined as the ratio of the light power from the corresponding focal spot (in glass) to the incident (in glass) light power. It will be understood that both diffraction and focusing efficiencies obtained in our simulations should not be directly compared to the experimental values that were measured in air, because of the reflections at the glass-air interface. Considering the fact that all optical fields propagate at directions close to the normal to the OMS surface and disregarding multiple reflections, one can estimate the expected difference between the quantities obtained for the fields in air and in glass as ηₐᵢᵣ ≈ 0.93η_{glass}, i.e., the difference amounts to ~ 7%.

### Fabrication and Assembly of the MEMS-OMS Devices

The OMSs for developing MEMS-OMS for dynamic beam steering/focusing were fabricated using standard electron-beam lithography (EBL), thin-film deposition and lift-off techniques. First, a 100 nm thick poly(methyl methacrylate) (PMMA, 2% in anisole, Micro Chem) layer and a 40 nm thick conductive polymer layer (AR-PC 5090, Allresist) were successively spin-coated on a 16 × 16 mm² glass substrate (Borofloat33 wafer, Wafer Universe). Note that the glass substrate was preprocessed to have a 10-µm-high circular/cross-shaped pedestal on one side using optical lithography and wet etching. The OMSs were then defined on the pedestal of the glass substrate using EBL (JEOL JSM-6500F field emission scanning electron microscope with a Raith Elphy Quantum lithography system) and subsequently developed in 1:3 solution of methyl isobutyl ketone (MIBK) and isopropyl alcohol (IPA). After development, a 1 nm Ti adhesion layer and a 50 nm Au layer were deposited using thermal evaporation. The Au nanobricks were finally formed atop the pedestal on the glass substrate after a lift-off process. Owing to the large size of the MEMS mirror (~ 3 mm in diameter) in comparison to the OMS (30×30 µm² in size), the pedestal on the glass substrate is very practical for reducing the possible contaminants between the MEMS mirror and OMS surface, thus promising high-efficiency modulation of the MEMS-OMS devices.

The MEMS mirror, which is very similar to the previously reported ultra-planar, long-stroke and low-voltage piezoelectric micromirror, is fabricated using standard semiconductor manufacturing processes and incorporating thin film lead zirconate titanate (PZT) for actuation. First, a platinum (Pt) bottom electrode, a 2-µm-thick PZT film and a top electrode consisting of TiW/Au were deposited on a silicon-on-insulator (SOI) wafer. Then a central circular aperture of 3 mm was opened by using deep reactive ion etching (DRIE) of silicon and etching of the buried oxide. An annulus trench is etched into the backside of the wafer, thereby releasing the circular plate. Finally, the wafer backside is sputtered with Au for acting as the ultra-flat MEMS mirror that is of vital importance in developing dynamic MEMS-OMS. After the fabrication of both OMS and MEMS mirror, we move to the assembly and packaging processes for making MEMS-OMS devices. Before assembly, the surface topography of the MEMS mirror and glass substrate were measured by a white light interferometry (Zygo NewView 6000), so as to select favorable areas on both sides with the least amount of contaminants and surface roughness that might obstruct the MEMS mirror from getting close enough to the OMS. Then, the MEMS mirror was glued to the glass substrate upon which the OMS has been structured. Getting the mirror and OMS parallel was done by adjusting the tilt of the MEMS mirror using the piezoelectric electrodes. The spacing between the MEMS mirror and the glass substrate (tₐ+tₘ) was measured to be commonly - 2 µm after mounting, well within the 6-µm moving range of the MEMS mirrors. Finally, the MEMS-OMS was glued to a printed circuitry board (PCB), and gold wire bonding is used to connect electrically to the MEMS electrodes for enabling simple connection to a voltage controller used to actuate the MEMS mirror.

After the MEMS-OMS assembly, we applied multi-wavelength interferometry to estimate the smallest achievable separation between the MEMS mirror and OMS surface. We found by actuating the MEMS mirror that, for several assemblies, this gap (tₘ+tₐ) can be as small as ~ 100 nm corresponding to tₐ ~ 50 nm, and these samples were then selected for further optical characterizations.

### Optical Characterization of MEMS-OMS

To characterize the performances of the MEMS-OMS for dynamic 2D wavefront shaping, we used a fiber-coupled wavelength-tunable Ti:sapphire laser (Spectra Physics 3900S, wavelength range: 700-1000 nm), whose light was directed through a half-wave plate (HWP, AHWP05M-980, Thorlabs), a Glan-Thomson polarizer and a first beam splitter (BS₁, BS014, Thorlabs) successively, and then focused by an objective (Obj, M Plan Apo, 20×/50× magnifications, Mitutoyo) onto the MEMS-OMSs. The reflected light was collected by the same objective and directed via BS₁ and a second BS (BS₂, BS014, Thorlabs) to two optical paths terminated with two CCD cameras (DCC1545M, Thorlabs) for visualizing respective direct object and Fourier plane images. Note that the objective of 20×/0.42 and 50×/0.55 are employed for measuring respective MEMS-OMS for dynamic beam steering and focusing.

During the measurement, the MEMS mirror was electrically actuated to modulate the optical responses of the MEMS-OMS devices. To characterize the MEMS-OMS for dynamic beam steering, we measured both diffraction efficiencies and response time. For estimating the diffraction efficiencies, we recorded the intensity of spatially separated 0^{th}/±1^{st} diffraction orders using a CCD camera at the Fourier plane for the laser beam being on the OMS area, which is then normalized with the reflection intensity from an unstructured substrate in the MEMS-OMS components. The response time of the MEMS-OMS was evaluated by actuating the MEMS mirror with a periodic rectangle signal from a function generator (TOE 7402, TOELLNER). The spatially separated diffraction orders at the Fourier plane could be selected by an iris and then projected to a photodetector (PDA20CS-EC, Thorlabs), which was connected to an oscilloscope (DSOX2024A, Keysight) for visualizing and recording the corresponding modulated signals. In the response time measurement, we recorded the 0^{th}/+1^{st} diffraction orders of the MEMS-OMS components, showing overall good repeatability and stability of the actuated MEMS-OMS components with the periodically electrical signals (FIG. 4D).

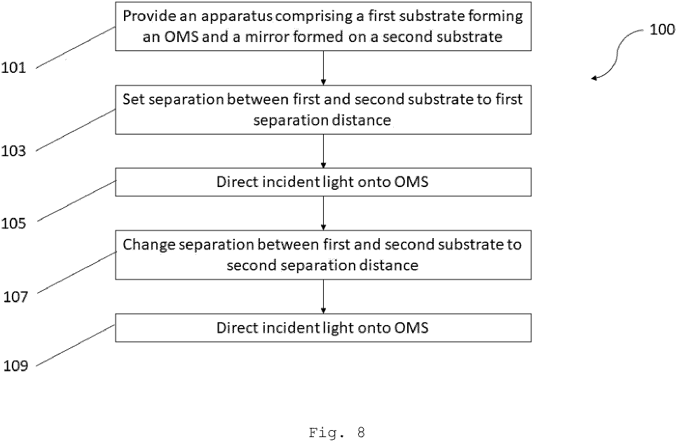

FIG. 8 shows a method 100 in accordance with the invention. It will be understood that the method 100 uses the system 7 shown in FIG. 7. At step 101, the apparatus (such as the apparatus shown in FIGS. 1A to 1C) is provided, comprising at least a first substrate comprising a nanostructured surface such that the first substrate forms an optical metasurface (OMS) and a mirror formed on a second substrate. At step 103, the separation between the first and second substrates is set to a first separation distance. In the illustrated embodiment, the mirror is a MEMS mirror 10 and the separation between the first substrate and the second substrate is set by applying a voltage across the MEMS mirror as discussed above in relation to FIGS. 1A to 1C. At step 105, incident light 14 is directed onto the OMS using the light source 16. The light 14 undergoes a manipulation - e.g. beam steering or focusing.

At step 107, the separation between the first and second substrates is changed to a second separation distance which is different to the first separation distance using the same mechanism discussed above. At step 109, incident light 14 is again directed onto the OMS using the light source 16. The previous manipulation is no longer applied. This may be because no manipulation is applied - i.e. it is turned off - or because a different manipulation is applied or the manipulation is otherwise changed.

We claim:

1. An apparatus comprising:
a first substrate comprising a nanostructured surface, thereby forming an optical metasurface;
a mirror formed on a second substrate; and
a mechanism arranged to move the first and second substrates relative to one another to alter a separation between the first and second substrates between a first separation distance and at least a second separation distance wherein at said first separation distance said optical metasurface performs a first manipulation of incident light and at said second separation distance said optical metasurface does not perform said first manipulation of incident light.

2. The apparatus of claim 1 wherein said first substrate has a first side and a second side, said second substrate being disposed to face said first side and said incident light being incident on said second side.

3. The apparatus of claim 1 wherein said optical metasurface comprises a plasmon antenna array configured to form a gap surface plasmon metasurface when the separation between the first and second substrates is such that the optical metasurface performs a manipulation of incident light.

4. The apparatus of claim 1 wherein said optical metasurface is configured to act as a blazed grating when the separation between the first and second substrates is such that the optical metasurface performs a manipulation of incident light.

5. The apparatus of claim 1 wherein at said second separation distance said optical metasurface performs a second manipulation of incident light.

6. The apparatus of claim 1 wherein at said second separation distance said optical metasurface performs substantially no manipulation of incident light.

7. The apparatus of claim 6 wherein said mechanism is arranged to move the first and second substrates relative to one another to a third separation distance, between said first and second separation, whereat said optical metasurface performs a second manipulation of incident light.

8. The apparatus of claim 1 wherein the second substrate is provided by a Micro-electromechanical systems (MEMS) arrangement such that the second substrate is translatable upon application of a voltage.

9. The apparatus of claim 1 further comprising a feedback mechanism to regulate said separation distance and/or a degree of planarity of said second substrate.

10. An optical system comprising a light source arranged to emit light having at least a first wavelength onto an apparatus, the apparatus comprising:
a first substrate comprising a nanostructured surface, thereby forming an optical metasurface;
a mirror formed on a second substrate; and
a mechanism arranged to move the first and second substrates relative to one another to alter a separation between the first and second substrates between a first separation distance and at least a second separation distance wherein at said first separation distance said optical metasurface performs a first manipulation of said light and at said second separation distance said optical metasurface does not perform said first manipulation of said light.

11. The optical system of claim 10 wherein the first separation distance is less than 1/10 of said first wavelength.

12. The optical system of claim 10 wherein the second separation distance is more than ¼ of said first wavelength.

13. The apparatus of claim 10 wherein said first substrate has a first side and a second side, said second substrate being disposed to face said first side and said light source emitting said light onto said second side.

14. The optical system of claim 10 wherein said optical metasurface comprises a plasmon antenna array configured to form a gap surface plasmon metasurface when the separation between the first and second substrates is such that the optical metasurface performs a manipulation of incident light.

15. The optical system of claim 10 wherein said optical metasurface is configured to act as a blazed grating when the separation between the first and second substrates is such that the optical metasurface performs a manipulation of incident light.

16. The optical system of claim 10 wherein at said second separation distance said optical metasurface performs a second manipulation of incident light.

17. The optical system of claim 10 wherein at said second separation distance said optical metasurface performs substantially no manipulation of incident light.

18. The optical system of claim 17 wherein said mechanism is arranged to move the first and second substrates relative to one another to a third separation distance, between said first and second separation, whereat said optical metasurface performs a second manipulation of incident light.

19. The optical system of claim 10 wherein the second substrate is provided by a Micro-electromechanical systems (MEMS) arrangement such that the second substrate is translatable upon application of a voltage.

20. The optical system of claim 10 further comprising a feedback mechanism to regulate said separation distance and/or a degree of planarity of said second substrate.

21. A method comprising:
providing an apparatus comprising:
a first substrate comprising a nanostructured surface, thereby forming an optical metasurface; and
a mirror formed on a second substrate;
setting a separation between the first and second substrates to a first separation distance;
directing incident light onto said optical metasurface, said optical metasurface performing a first manipulation of said incident light;
moving the first and second substrates relative to one another to a second separation distance; and
directing incident light onto said optical metasurface, said optical metasurface not performing said first manipulation of incident light.

22. The method of claim 21 wherein at said second separation distance said optical metasurface performs a second manipulation of incident light.

23. The method of claim 21 wherein at said second separation distance said optical metasurface performs substantially no manipulation of incident light.

24. The method of claim 23 comprising moving the first and second substrates relative to one another to a third separation distance, between said first and second separation, and directing incident light onto said optical metasurface, said optical metasurface performing a second manipulation of incident light.
